(19) United States
(12) Patent Application Publication
(10) Pub. No.: US 2020/0064224 A1
(43) Pub. Date: Feb. 27, 2020

(54) TEST BENCH FOR TOOTHINGS

(71) Applicants: ZF Friedrichshafen AG, Friedrichshafen (DE); ZF Wind Power Antwerpen N.V., Lommel (BE); Sincotec Test & Engineering GmbH, Clausthal-Zellerfeld (DE)

(72) Inventors: Dirk Leimann, Edegem (BE); Joachim Hug, Clausthal-Zellerfeld (DE); Sven Henze, Clausthal-Zellerfeld (DE)

(21) Appl. No.: 16/466,691

(22) PCT Filed: Nov. 24, 2017
(86) PCT No.: PCT/EP2017/080347

§ 371 Date: Jun. 5, 2019

(30) Foreign Application Priority Data
Dec. 9, 2016 (DE) 10 2016 224 629.1

(51) Int. Cl. G01M 13/027; G01M 13/021

(52) U.S. Cl. CPC G01M 13/027; G01M 13/021

(57) ABSTRACT

The invention relates to a test bench (201, 1201) for toothings, comprising a sample receiver (209, 1211) and a first load generator (213, 1203, 1205), said first load generator (213, 1203, 1205) comprising at least one head (215, 1207). The sample receiver (209, 1211) is designed to receive at least one section (205) of a tooth sample (203) separated from the toothing of a gear wheel (101), said tooth sample (203) comprising a tooth of the gear wheel (101), and the head (215, 1207) lying against a flank (207) of the tooth and applying a load to said flank (207).

### CROSS REFERENCE TO RELATED APPLICATIONS

This application is a U.S. National Stage Application under 35 U.S.C. § 371 of International Application No. PCT/EP2017/080347 filed on Nov. 24, 2017, and claims benefit to German Patent Application No. DE 10 2016 224 629.1 filed on Dec. 9, 2016. The International Application was published in German on Jun. 14, 2018, as WO 2018/104077 A1 under PCT Article 21(2).

### FIELD

The invention relates to a toothing test bench having a sample receiver and a first load generator, a tooth sample having a tooth of a gear wheel, and a method for testing the toothing of a gear wheel.

### BACKGROUND

In order to test the load capacity of the toothing of a gear wheel, what are known as FZG test benches and pulsator test benches are known from the prior art. In an FZG test bench, the toothings of two gear wheels are brought into engagement and braced against one another. The gear wheels are normally models of larger gear wheels at a reduced scale. This involves the risk that the determined results cannot be transferred 1:1 to the larger gear wheels. Moreover, in an FZG test bench, the bracing and therefore the simulated load are typically static. The testing of dynamic loads is therefore not possible.

In a pulsator test bench, two teeth of the toothing of a gear wheel are braced between two punches. Dynamic loads can be applied by means of the punches. Due to the deformations in the gear wheel, however, the bearing surface of the punch on the teeth is not exactly defined. Moreover, it is not possible to simulate the roll-off movements of the individual teeth occurring in involute toothing. The testing of obliquely-toothed gear wheels is also possible only to a limited extent with conventional pulsator test benches. The direction of the forces introduced into the gear wheel by the punch runs orthogonally to an axis of rotation of the gear wheel.

### SUMMARY

In an embodiment, the present invention provides a toothing test bench. The toothing test bench includes a sample receiver and a first load generator. The first load generator has a head. The sample receiver is configured to receive at least one part of a tooth sample detached from a toothing of a gear wheel. The tooth sample comprises a tooth of the gear wheel. The head rests against a flank of the tooth and applies a load to the flank. The head is rotatably mounted, and an axis of rotation of the head and at least one engagement line of the tooth flank are skewed relative to each other.

### BRIEF DESCRIPTION OF THE DRAWINGS

The present invention will be described in even greater detail below based on the exemplary figures. The invention is not limited to the exemplary embodiments. All features described and/or illustrated herein can be used alone or combined in different combinations in embodiments of the invention. The features and advantages of various embodiments of the present invention will become apparent by reading the following detailed description with reference to the attached drawings which illustrate the following:

FIG. 1 illustrates a pulsator test bench known from the prior art;

FIG. 2 illustrates a toothing test bench, with a load generator;

FIG. 3 illustrates a partial view of a clamped tooth sample;

FIG. 4 illustrates the testing of the tooth sample using a load generator;

FIG. 5 illustrates specific sliding;

FIGS. 6a and 6b illustrate forces in the case of specific sliding;

FIG. 7 illustrates a test cycle;

FIG. 8 illustrates a two-headed toothing test bench;

FIG. 9 illustrates specific sliding in the two-headed toothing test bench;

FIG. 10 illustrates a gear wheel with outer toothing;

FIG. 11 illustrates a gear wheel with inner toothing; and

FIG. 12 illustrates a toothing test bench, with two load generators.

### DETAILED DESCRIPTION

Embodiments of the invention provide for testing the load response of the toothing of a gear wheel, while avoiding disadvantages inherent in solutions known from the prior art. In particular, embodiments of the invention provide for improved validity of the results of the testing.

An arrangement for testing the toothing of a gear wheel is referred to as a toothing test bench.

A toothing test bench according to an embodiment of the invention comprises a sample receiver, i.e., a means for receiving a sample or a test item, and a first load generator, i.e., a means for applying a load—in particular, a mechanical load. The first load generator has at least one head for transferring the load to the sample.

The sample is a tooth sample. This comprises one—preferably, precisely one—tooth detached from the gear wheel or from the toothing of the gear wheel. In particular, the tooth may have been detached from the gear wheel by means of a method of the third main group of the DIN 8580 standard.

The gear wheel is preferably an internally- or externally-toothed cylindrical gear. Its toothing may be executed as a spur toothing, for instance, but also as a helical toothing.

According to an embodiment of the invention, the sample receiver is designed to receive, i.e., suitably fix, the described sample. The fixing takes place in such a way that a load may be applied to a flank of the tooth.

The head of the first load generator, which rests on the flank of the tooth, serves to apply the load. The load is introduced into the flank via a corresponding contact surface of the head on the flank.

The load is a force that manifests itself in the contact surface as pressure. The force may be constant and/or variable over time.

Embodiments of the invention enable the toothing of a real gear wheel to be tested directly without the production of a down-scaled model. Since only a single tooth is tested, it is not necessary to clamp the gear wheel completely into the test bench.

This is advantageous particularly with large gearboxes—for instance, wind power gearboxes. Loads that vary as a function of time, corresponding to real situations, can additionally be simulated.

If toothings of two gear wheels mesh with one another, individual teeth that respectively engage roll or slide off one another. In order to simulate this, the tooth sample, including the tooth and the head, are preferably movable relative to one another. In a preferred embodiment, at least one actuator is, accordingly, provided in order to move the head of the first load generator and the tooth sample relative to one another.

An actuator is to be understood as an energy converter which converts a first energy form, e.g., electrical energy, into a second energy form—here, kinetic energy.

In a further preferred embodiment, a repeated tooth engagement of intermeshing toothings is simulated by an oscillating movement of the head and the tooth sample relative to one another. An oscillating movement is characterized by a reversal of the direction of movement that is repeated multiple times. The term, “oscillating movement,” is equivalent to an oscillation. According to the embodiment, the actuator therefore excites the head and the tooth sample to oscillate relative to one another.

The tooth engagement of intermeshing toothings takes place along the contact surfaces of the respectively engaged teeth. A corresponding preferred embodiment of the invention provides that the movement of the head and of the tooth sample relative to one another take place along or parallel to a mutual contact surface. A direction of this movement is directed orthogonally to a surface normal of this contact surface.

In a further preferred embodiment, the loading of the flank by the head takes place at least partially in the direction of the aforementioned surface normals. According to the embodiment, a non-zero directional vector of a corresponding force thus acts in this direction.

In order to apply the aforementioned load, in a preferred embodiment, the head of the first load generator is braced against the flank. For this purpose, in a further preferred embodiment, a spring element is provided that is braced against the head. Specifically, the spring element is braced between the head and a stationary means. The stationary means is a component of the first load generator which, for instance, may be fixed in the aforementioned stationary structure.

The relative movability of the head of the first load generator and of the tooth sample can be achieved by a movable head and/or a movable tooth sample. In a preferred embodiment, the head is thus movably fixed and the tooth sample is thus stationarily or rigidly fixed in the sample receiver, i.e., without the possibility of a relative movement. This implies that the sample receiver is also fixed in a stationary or rigid manner. The aforementioned actuator thereby acts on the head of the first load generator. Preferably, the movement of the head takes place along or parallel to the contact surface of the head and the flank.

In an alternative preferred embodiment, the relative mobility of the head and of the load generator is achieved via a movable—preferably, translationally movable—tooth sample. In this instance, the aforementioned actuator acts on the tooth sample.

In a further preferred embodiment, the head is also movable—preferably, translationally—so that the head rests continuously on the flank while the tooth sample moves, so that the loading of the flank is continuously maintained by the head. This enables the head to follow the movements of the flank. In particular, the direction of movement of the head should be anti-parallel to a surface normal of the contact surface between the head and the flank. A prerequisite for loading the flank of the tooth is thereby satisfied via a force applied to the tooth via the head in the direction of the mobility of the head.

The movements of the tooth sample and of the head occur relative to a stationary structure—for instance, a housing of the toothing test bench. The tooth sample and/or the head are preferably fixed, e.g., in the stationary structure, so that movements are possible exclusively in the specified directions.

The tooth sample is preferably clamped symmetrically in the toothing test bench. This means that a plane, with respect to which the tooth is two-dimensionally symmetrical, and the direction of movement of the tooth sample are aligned parallel to one another. With regard to the gear wheel from which the tooth sample was detached, the direction of the mobility of the movements of the tooth sample preferably extends radially, i.e., orthogonally to an axis of rotation or central axis of the gear wheel. This corresponds to a central axis of the tooth sample.

In a further preferred embodiment, the head is rotationally symmetrical. In particular, the head can be designed as a cylindrical roller. This leads to a linear contact between the head and the flank of the tooth. Accordingly, the head applies a linear load to the flank of the tooth.

An embodiment of the head in which it is rotatably mounted is particularly preferred. This enables the head to perform a roll-off movement on the flank of the tooth. The roll-off movement of the head corresponds, with involute toothings, to the occurrence of a rolling tooth engagement.

An axis of rotation of the rotatably-mounted head may be crossed relative to at least one flank line of the tooth flank. This means that the axis of rotation and the flank line are skewed relative to one another. The crossing of the axis of rotation with respect to the flank line preferably occurs in such a way that the axis of rotation, starting from a course parallel to the flank line, is rotated about a surface normal of the contact surface of the head and the flank of the tooth. As a result, due to the movements of the tooth sample in the first direction and/or of the head in the second direction, the head not only rolls off at the flank of the tooth, but is also subject to a sliding movement orthogonal to the direction of the roll-off. A load on the flank can thereby be simulated via what is known as “specific sliding.”

To simulate multi-axis load states, in a preferred embodiment, the first load generator has at least two heads of the type described above, which heads rest on the same flank of the tooth and each apply a load to the flank. The two heads are spatially separate from one another and contact the flank of the tooth at spatially separate contact surfaces. The loads applied by the heads to the flank of the tooth are therefore also spatially separate from one another.

The use of two heads enables a flexural stressing of the tooth to be deliberately induced with one of the heads, while the other head—closer to the tooth base—produces a weakening of the surface of the flank of the tooth via the compressive stress. Based thereon, the fatigue strength of the tooth can be determined with respect to both compression and bending. Both factors are known sources of failure.

The at least two heads are respectively movable in a direction that runs anti-parallel to a surface normal of a contact surface of the respective head and the flank of the tooth. In addition to this, each of the heads is preferably braced against the flank. Spring elements can be provided for this purpose, each being braced between the heads and the fixed structure. Alternatively, it is possible to load the heads respectively with an actuator or to set them into an oscillating movement. Moreover, the heads are preferably rotationally symmetrical or designed as a roller and rotatably mounted. In order to simulate specific sliding, the axes of rotation of the two heads may be crossed relative to at least one respective flank line of the flank of the tooth.

Instead of the second head, the toothing test bench may have a second load generator. This loads the tooth together with the first load generator and produces a bending moment.

In a preferred embodiment, the bending moment pulsates, meaning that the bending moment can be described as a periodic or non-periodic, damped or undamped, linear or non-linear oscillation function.

In a further preferred embodiment, the bending moment or a vector of the bending moment is directed orthogonally to a surface normal of the flank. The surface normal preferably extends through the contact surface of the head and the flank.

In a preferred embodiment, the bending moment may also run axially with respect to the aforementioned gear wheel.

In a further preferred embodiment, the pulsating bending moment completes a zero crossing. A zero crossing is equivalent to a change of sign. With a zero crossing, the bending moment changes its direction.

According to an embodiment of the invention, the tooth sample comprises one—preferably, precisely one—tooth of a gear wheel and a shaft for fixing in the sample receiver of the above-described toothing test bench. The shaft can be approximately at least partially cuboid or cylindrical in shape. The tooth sample has been detached from the gear wheel. This implies that the tooth sample was previously a component of the gear wheel.

A method according to an embodiment of the invention for testing the toothing of a gear wheel comprises the following steps: detaching a tooth from the gear wheel; and testing the tooth by means of a toothing test bench of the type described above.

The detachment of the tooth may take place via sawing or cutting, for instance. Sawing is defined in the DIN 8589 standard. The DIN 8588 standard defines cutting.

The method step of testing comprises a partial step of clamping the tooth into the toothing test bench and a partial step of loading the tooth by means of the toothing test bench. The tooth is clamped in the toothing test bench by being fixed in the sample receiver. The loading of the tooth is designed such that a load is applied to a flank of the tooth via the head or heads of the toothing test bench.

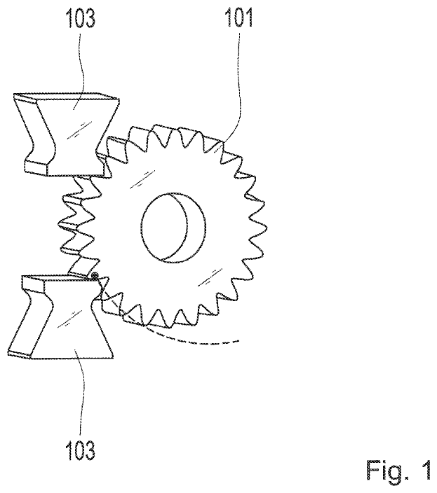

The gear wheel 101 depicted in FIG. 1 is clamped between two punches 103 of a conventional pulsator test bench for purposes of simulating a dynamic load situation. The punches 103 engage in the toothing of the gear wheel 101 and apply a load.

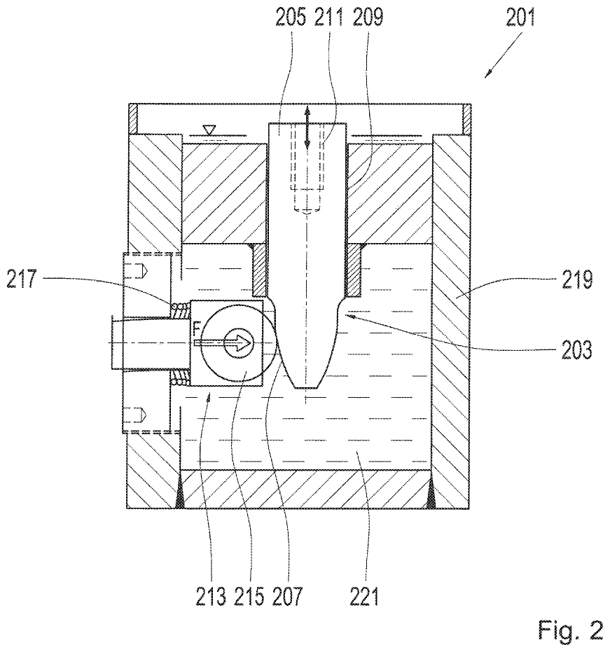

Conventional pulsator testing benches have a number of disadvantages which can be avoided with the toothing test bench 201 shown in FIG. 2. A tooth sample 203 to be tested is clamped in the toothing test bench 201. The tooth sample 203 is characterized in that it is not a model produced for the purposes of testing, but rather has been extracted from a serviceable gear wheel.

The tooth sample 203 comprises a shaft 205 and two tooth flanks 207. The tooth sample 203 is clamped by the shaft 205 in a sample receiver 209. The sample receiver 209 guides the tooth sample 203 in a vertical direction.

The shaft 205 has a blind bore which opens upward, the bore having an internal thread 211. Via the internal thread 211, the tooth sample 203 may be connected to an actuator (not shown in FIG. 2) which moves the tooth sample 203 up and down.

In order to simulate a load acting on the flank 207, the toothing test bench 201 has a load generator 213. A rotatably-mounted roller 215 of the load generator 213 is in contact with the flank 207. The roller 215 is biased by means of a spring 213. A force F of the spring 213 acts in a horizontal direction on the roller 215 and presses this against the flank 207.

A housing 219 encapsulates the components of the toothing test bench. The load generator 213 is fixed in the housing 219. Furthermore, the housing 219 forms the sample receiver 209. Located inside the housing 219 is an oil bath 221 into which the flank 207 of the tooth sample 203 and the roller 215 of the load generator 213 are immersed. The oil lubrication present in a real gearbox can be simulated by the oil bath 221.

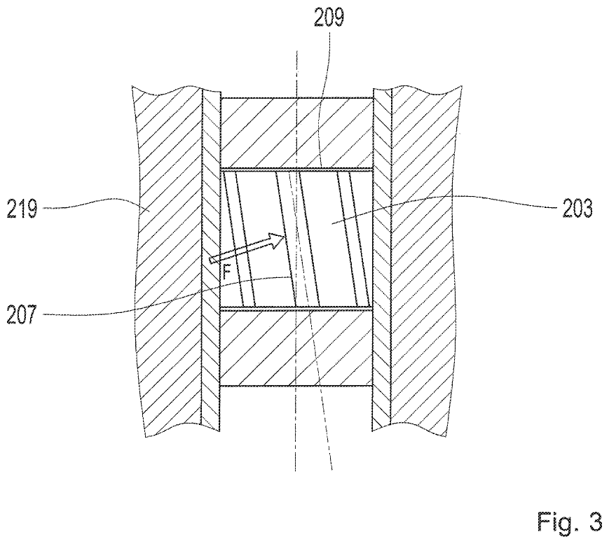

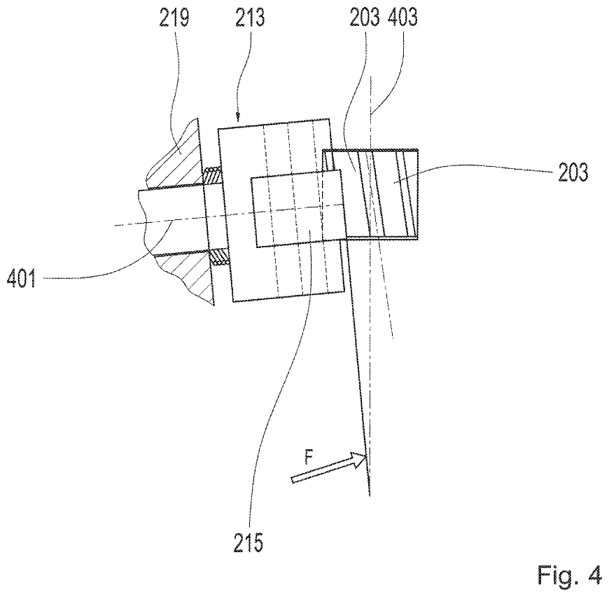

A bottom view of the tooth sample 203 is shown in FIG. 3. It can be seen here that this is a section of a helical toothing. The force F that acts on the flank 207 of the tooth sample 203 for testing purposes must, accordingly, be oriented obliquely. This is achieved by a correspondingly inclined orientation of the load generator 213, as shown as in FIG. 4.

According to FIG. 4, a major axis 401 along which the roller 215 can slide and in whose direction a force may accordingly be applied extends orthogonally to the flank 207 of the tooth sample 203. The flank 207 in turn runs anti-parallel to a major axis 403 of the toothing test bench 201. The major axis 403 is aligned parallel to an axis of rotation of the gear wheel 101 from which the tooth sample 203 has been detached. In particular, the major axis 401 of the load generator 213 and the major axis 403 of the toothing test bench 203 are thus not orthogonal to one another.

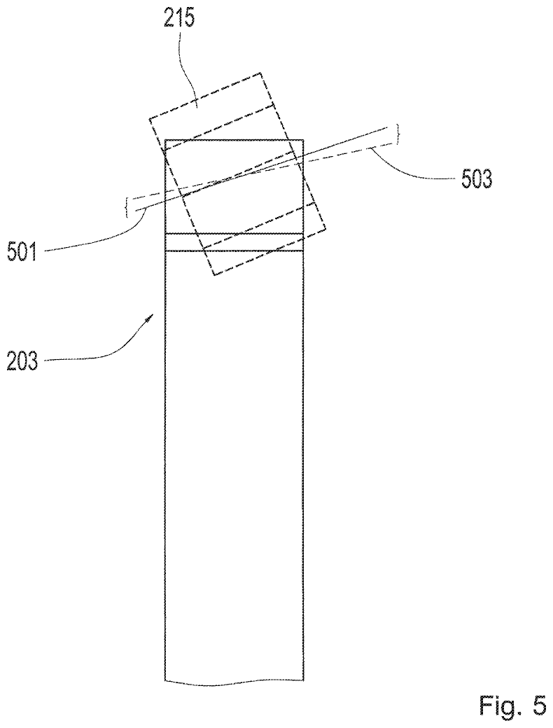

The direction of the perspective shown in FIG. 5 corresponds to the direction of the force F applied by the load generator 213. From this perspective, a crossing of a rotational axis 501 of the roller 215 of the load generator 213 relative to a line of engagement 503 is apparent. The line of engagement 503 indicates a region in which the flank 207 of the tooth sample 203 is loaded by the roller 215. In particular, a contact between the roller 215 and the flank 207 exists along the line of engagement 503. As a result of the crossing, the rotational axis 501 of the roller 215 and the line of engagement 503 run anti-parallel. This produces what is known as a “specific sliding” of the roller 215. The roller 215 thereby moves not only by rolling, but also by sliding over the surface of the flank 207. Real, prevailing load relationships can thereby be exactly simulated.

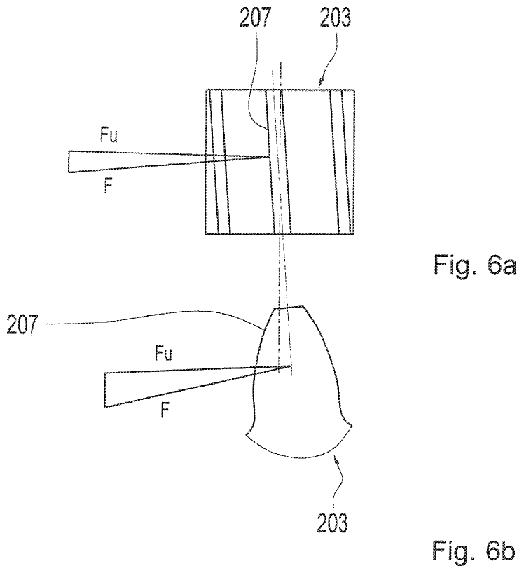

The resulting force relationships are illustrated in FIGS. 6a and 6b. A first component of a force F applied by the load generator 213 on the flank 207 acts in the flank as a normal force Fn orthogonal to the flank 207. A second component of the force F is perpendicular to Fn.

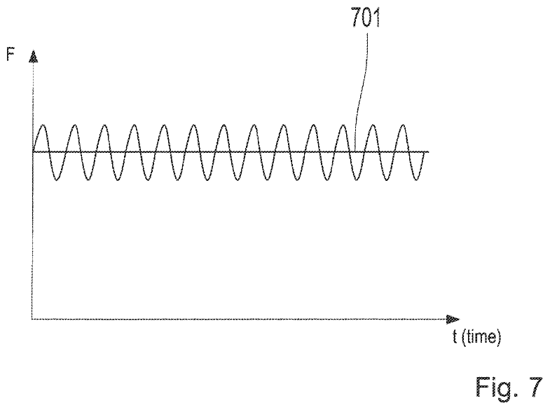

FIG. 7 depicts the force F which is applied by the roller 215 to the flank 207 of the tooth sample 203 over time. Also shown is a test load 701 which, at rest, is applied by the spring 217. Via the up and down movement of the tooth sample 203, the force F describes a periodic progression fluctuating around the test load 701.

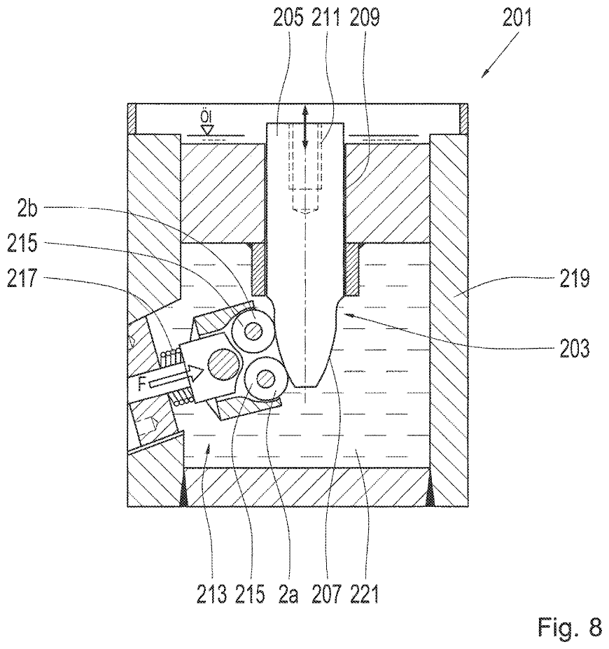

FIG. 8 shows a variant of the toothing test bench 201 with two rollers 215. Both rollers 215 abut the flank 207 of the tooth sample 203 and are charged with a load by the spring 217. In this way, a more realistic simulation of the real, prevailing load relationships can be realized.

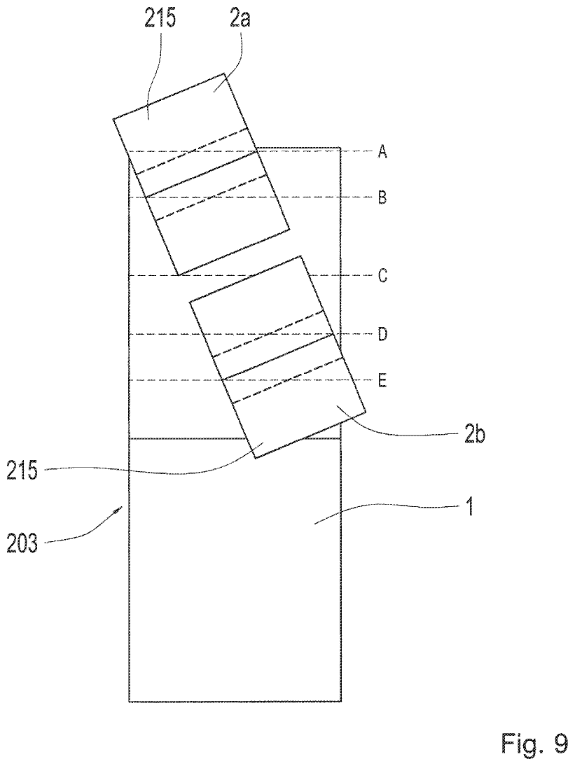

As shown in FIG. 9, analogously to FIG. 5, the rollers 215, in an embodiment that is present twice, are also crossed with respect to their lines of engagement in order to simulate specific sliding.

The gear wheel 101 from which the tooth sample 203 has been detached may be an internally-toothed or an externally-toothed gear wheel 101.

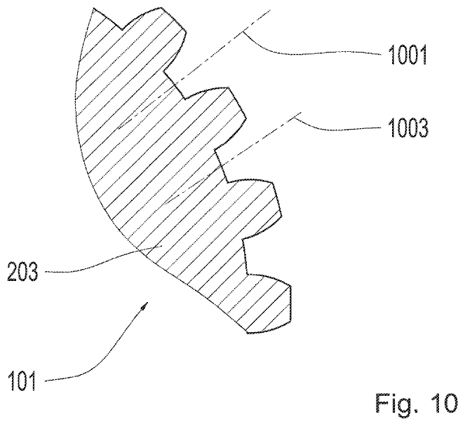

FIG. 10 depicts an externally-toothed gear wheel 101. The tooth sample 203 is detached from the gear wheel 101 along a first cut surface 1001 and a second cut surface 1003. The first cut surface 1001 and the second cut surface 1003 extend parallel to each other.

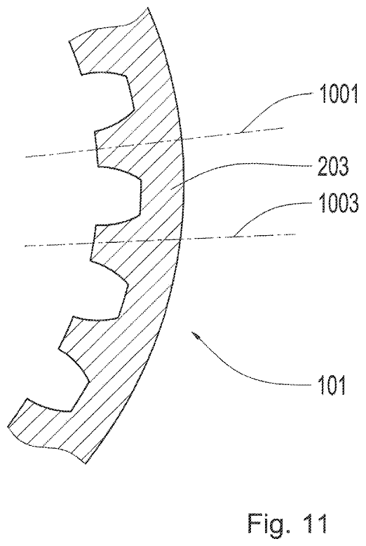

FIG. 11 analogously depicts an internally-toothed gear wheel 101. The tooth sample 203 is detached from the gear wheel 101 along the first cut surface 1001 and the second cut surface 1003. Here, too, the first cut surface 1001 and the second cut surface 1003 run parallel to each other.

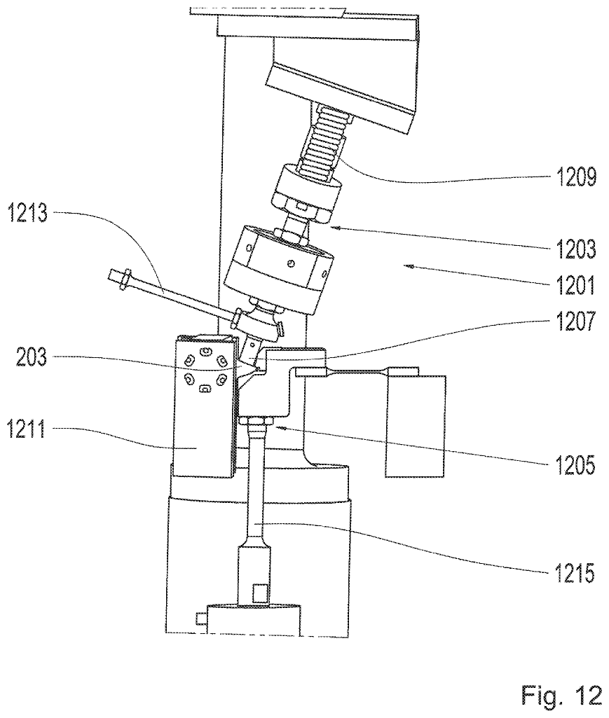

In addition to a first load generator 1203, the toothing test bench 1201 that is depicted in FIG. 12 has a second load generator 1205. The first load generator 1203 exerts a load on the flank 207 of the tooth sample 203 via a roller 1207. This load is applied by a spring 1209.

The tooth sample 203 is fixed so as to be stationary in a likewise stationary sample receiver 1211. Instead of the sample receiver 1211, here, the first load generator 1203 is movable. The first load generator 1203 may thus be pivoted orthogonally to a force that is applied to the flank 207 of the tooth sample 203 via the roller 1207. As a result of this, the roller 1207 rolls off the flank 207. A force applied by the spring 1209 thereby continuously acts on the roller 1207.

The first load generator 1203 is pivoted by means of an actuator (not shown in FIG. 12) which is connected to the first load generator 1203 via a first coupling rod 1213.

The second load generator 1205 engages at a head of the tooth sample 203 and exerts a pulsating tensile force. For this purpose, the second load generator 1205 is suspended so as to be linearly movable. The second load generator 1205 is connected to a further actuator (not shown in FIG. 12) via a second coupling rod 1215.

The tensile force applied by the second load generator 1205 manifests itself in the tooth sample 203 as a pulsating bending moment whose vector is directed orthogonally to the image plane of FIG. 12. This bending moment corresponds to a structural loading of the tooth sample 203. Together with the superficially acting load applied by the roller 1207, the load situation acting in a real tooth engagement can thus be realistically simulated.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

### LIST OF REFERENCE NUMERALS

101 Gear wheel

103 Punch

201 Toothing test bench

203 Tooth sample

205 Shaft

207 Flank

209 Sample receiver

211 Internal thread

213 Load generator

215 Roller

217 Spring

219 Housing

221 Oil bath

401 Major axis of the load generator

701 Test load

1001 First cut surface

1003 Second cut surface

1201 Toothing test bench

1203 First load generator

1205 Second load generator

1207 Roller

1209 Spring

1211 Sample receiver

1213 First coupling rod

1215 Second coupling rod

1-24. (canceled)

25. A toothing test bench, comprising:
a sample receiver; and
a first load generator,
wherein the first load generator has a head;
wherein the sample receiver is configured to receive at least one part of a tooth sample detached from a toothing of a gear wheel;
wherein the tooth sample comprises a tooth of the gear wheel;
wherein the head rests against a flank of the tooth and applies a load to the flank;
wherein the head is rotatably mounted; and
wherein an axis of rotation of the head and at least one engagement line of the tooth flank are skewed relative to each other.

26. A toothing test bench, comprising:
a sample receiver,
a first load generator, and
a second load generator,
wherein the first load generator has a head;
wherein the sample receiver is designed to receive at least one part of a tooth sample detached from a toothing of a gear wheel;
wherein the tooth sample comprises a tooth of the gear wheel;
wherein the headrests against a flank of the tooth and applies a load to the flank;
wherein the head is movable;
wherein the tooth sample is fixed in a stationary manner; and
wherein the second load generator is configured to introduce a force into a tooth head of the tooth.

27. The toothing test bench according to claim 25, further comprising at least one actuator, wherein the actuator is configured to move the head and the tooth sample relative to one another.

28. The toothing test bench according to claim 27, wherein the actuator produces an oscillating movement of the head and the tooth sample relative to one another.

29. The toothing test bench according to claim 28, wherein the movement of the head and the tooth sample relative to one another takes place along a contact surface of the head and the flank.

30. The toothing test bench according to claim 25, wherein the head loads the flank at least partially in a direction of a surface normal of a contact surface of the head and the flank.

31. The toothing test bench according to claim 25, wherein the head is braced against the flank.

32. The toothing test bench according to claim 31, wherein the first load generator has at least one spring element, and wherein the spring element is braced against the head.

33. The toothing test bench according to claim 25, wherein the tooth sample is fixed in a stationary manner, and wherein the head is movable.

34. The toothing test bench according to claim 25, wherein the tooth sample is translationally movable.

35. The toothing test bench according to claim 34, wherein the head is movable.

36. The toothing test bench according to claim 25, wherein the head is rotationally symmetrical.

37. The toothing test bench according to claim 36, wherein the head is designed as a cylindrical roller.

38. The toothing test bench according to claim 34, wherein the first load generator has at least two heads, wherein the heads rest against the flank and respectively apply a load to the flank.

39. The toothing test bench according to claim 38, wherein the bending moment pulsates.

40. The toothing test bench according to claim 26, wherein a bending moment is directed orthogonally to a surface normal of the flank.

41. The toothing test bench according to claim 40, wherein the surface normal extends through the contact surface of the head and the flank.

42. The toothing test bench according to claim 26, wherein a bending moment runs axially relative to the gear wheel.

43. The toothing test bench according to claim 40, wherein the bending moment completes at least one zero crossing.

44. A tooth sample, comprising:
a tooth of a gear wheel,
wherein the tooth sample has been detached from the gear wheel; and
wherein the tooth sample has a tooth of the gear wheel a shaft to be accommodated in a toothing test bench according to claim 25.

45. A method for testing the toothing of a gear wheel, the method comprising:
detaching, from a gear wheel, a tooth sample of the gear wheel; and
testing the tooth with a toothing test bench according to claim 25.
